(19) United States
(12) Patent Application Publication
(10) Pub. No.: US 2012/0153900 A1
(43) Pub. Date: Jun. 21, 2012

(54) TWO-WAY SWITCHING REGULATOR

(75) Inventor: Lon Schneider, Centennial, CO (US)

(73) Assignee: Nexergy, Inc., Columbus, OH (US)

(21) Appl. No.: 12/973,308

(22) Filed: Dec. 20, 2010

(51) Int. Cl. G05F 1/46; H02J 7/34

(52) U.S. Cl. 320/128; 323/283

(57) ABSTRACT

Two-way voltage switching may be performed using a single switch mode regulator circuit such that only control signals and feedback signals are used to select the direction of the power path. Such voltage switching may be between a battery and a supply rail that operate at different voltage levels. The voltage level of the battery's output may be converted by the regulator to the voltage level of the supply rail such that at least a portion of the power drawn by the system from the supply rail is from the rechargeable battery. To charge the rechargeable battery from the supply rail, the voltage of the supply rail may be converted to the voltage level of the battery using the same switch mode regulator. To select between discharging the battery into the supply rail or charging the battery from the supply rail, no power path circuitry need be switched.

### CROSS REFERENCES

This application is related to U.S. Pat. No. ______, entitled “Use of a JFET as a Failsafe Shutdown Controller,” Attorney Docket Number 040328-000600US, filed on Dec. 20, 2010, the entire disclosure of which is hereby incorporated by reference for all purposes.

### BACKGROUND OF THE INVENTION

1. Field of the Invention

The present invention relates generally to the field of regulator controllers. One embodiment of the invention relates to using a switch mode regulator controller in a boost mode and in a buck mode. More specifically, one embodiment of the invention relates to using a switch mode regulator controller to alternatively discharge a battery to a supply rail and charge the battery from the supply rail.

2. Background

A battery, such as a rechargeable battery, may be used as a power source for when a power source fails, possibly due to a power failure. The rechargeable battery may allow for the device or devices it is coupled with to continue operating and/or complete various functions before the rechargeable battery runs out of power. For instance, the rechargeable battery may allow a storage device to backup data before the battery exhausts its charge.

Considering that batteries' storage capacities degrade over time, it may be useful to have an accurate determination of the amount of time that the battery can be expected to function effectively when it is used as a power source. In order to make this determination, it may be necessary to discharge at least a portion of the battery's charge and to do so at a rate different from a normal load. Measurements taken during such a discharge may be used to identify various characteristics of the rechargeable battery, such as its full charge capacity, remaining capacity, and state of health.

A resistive load can be used for this purpose. However, such a resistive load generates heat that would increase the ambient temperature of the battery, and may reduce its effective lifetime. Placing the resistive load outside of the battery's casing, such as inside the product being powered, may also be detrimental.

### BRIEF SUMMARY OF THE INVENTION

Two-way voltage switching may be performed using a switch mode regulator controller. Such voltage switching may be between a battery and a supply rail that operate at different voltage levels. The voltage level of the battery's output may be converted by the regulator to the voltage level of the supply rail such that at least a portion of the power drawn by a system from the supply rail is from the rechargeable battery. To charge the rechargeable battery from the supply rail, the voltage of the supply rail may be converted to the voltage level of the battery using the same switch mode regulator controller without changing the power path.

In some embodiments, a system for performing two-way voltage switching using a regulator is presented. The system may include a first voltage supply circuit, wherein the first voltage supply circuit at least occasionally supplies at least one other circuit with a first voltage. The system may include a second voltage supply circuit. The second voltage supply circuit may at least occasionally supply at least one other circuit with a second voltage. The second voltage may be lower in magnitude than the first voltage. The system may include a regulator. The regulator may have a buck mode and a boost mode. The regulator may switch between the buck mode and the boost mode based on a mode input. The regulator may be coupled with the first voltage supply circuit and the second voltage supply circuit. The system may include a mode module, comprising a selection input, a boost configuration circuit and a buck configuration circuit. The mode module may be coupled with the first voltage supply circuit and the second voltage supply circuit. The mode module, based on the selection input, may function in a boost configuration or a buck configuration. The boost configuration may provide the mode input to set the regulator to boost mode. The buck configuration may provide the mode input to set the regulator to buck mode. The selection input may activate the boost configuration or the buck configuration of the mode module.

In some embodiments, when the mode module is in the boost configuration, the regulator causes the generation of a third voltage, using the second voltage, that is applied to the first voltage supply circuit; and the third voltage is approximately equal to the first voltage. In some embodiments, when the mode module is in the buck configuration, the regulator causes the generation of a third voltage, using the first voltage, that is applied to the second voltage supply circuit, and the third voltage is approximately equal to the second voltage. The first voltage supply circuit may be a rechargeable battery. The second voltage supply circuit may be a rechargeable battery. When the mode module is in the boost configuration, an amount of electrical energy stored in the rechargeable battery may be converted from the second voltage level to the first voltage level and discharged into the first voltage supply circuit. When the mode module is in the buck configuration, the first voltage of the first voltage supply circuit may be converted to charge the rechargeable battery at the second voltage. In some embodiments, the system further comprising at least one switch, wherein the at least one switch outputs the selection input to the mode module. The at least one switch may be a logic controlled analog switch. In some embodiments, the regulator is a switching regulator controller or a synchronous switching regulator controller.

In some embodiments, a method for creating a first voltage using a second voltage, and the second voltage using the first voltage is presented. The method may include transitioning a regulator to a buck mode, wherein the regulator has a boost mode and the buck mode. The method may include generating the second voltage using the regulator while the regulator is in the buck mode, wherein the first voltage is used to create the second voltage. The method may include applying the second voltage generated using the regulator and the first voltage to a second voltage source. The method may include transitioning the regulator to the boost mode. The method may include generating the first voltage using the regulator while the regulator is in the boost mode, wherein the second voltage is used to create the first voltage. The method may also include applying the first voltage generated using the regulator to a first voltage source.

In some embodiments, a system for performing two-way voltage switching is present. The system may include a first means for regulating a voltage, wherein the first means functions in a boost mode and a buck mode based on a mode input. The system may include a second means. The second means may create a first voltage. The second means may be coupled with the first means. The system may include a third means. The third means may create a second voltage. The third means may be coupled with the first means. The second voltage may be lower than the first voltage. The system may include a fourth means. The fourth means may be coupled with the first means. The fourth means may enable either the boost mode or the buck mode using the mode input. When the first means is in the boost mode, the second voltage may be used to generate a third voltage that is supplied to the second means. The first voltage and the third voltage may be approximately equal. When the first means is in the buck mode, the first voltage may be used to generate the third voltage that is supplied to the third means. The second voltage and the third voltage may be approximately equal.

### BRIEF DESCRIPTION OF THE DRAWINGS

FIG. 1 illustrates a high level block diagram of an embodiment of a system having a regulator controller configured for two-way voltage switching.

FIG. 2 illustrates another high level block diagram of an embodiment of a system having a regulator controller configured for two-way voltage switching.

FIG. 3 illustrates a high level block diagram of an embodiment of a system having a regulator controller configured for two-way voltage switching between a rechargeable battery and a supply rail.

FIG. 4 illustrates a circuit diagram of an embodiment of a regulator controller configured for two-way voltage switching.

FIG. 5 illustrates another circuit diagram of an embodiment of a regulator controller configured for two-way voltage switching.

FIG. 6 illustrates an embodiment of a method for two-way voltage switching.

FIG. 7 illustrates an embodiment of a method for two-way voltage switching between a rechargeable battery and a supply rail.

### DETAILED DESCRIPTION OF THE INVENTION

To determine a battery's capacity, it may need to be at least partially discharged. Such a discharge may involve discharging a portion or all of the stored electrical charge of the battery. Based upon the measurements taken during and/or after the discharge, it may be possible to determine various information about the battery, such as its full charge capacity, remaining capacity and state of health.

In order to discharge at least a portion of the electrical energy stored in the rechargeable battery (also referred to as the battery, for simplicity), the energy may be dissipated by some device or circuit internal or external to the rechargeable battery. One solution may be discharging the rechargeable battery's charge through a resistor. One possible disadvantage of such an arrangement is that the resistor, as current passes through it, produces heat. The greater the amount of current passing through the resistor, the greater the amount of heat that may be created. This may be a problem if the system is operating in a hot environment. Further, discharging the stored energy through a resistor may be a waste of energy.

A alternate solution may be to discharge the battery such that the energy removed from the battery is put into a system's load. Such loads may operate at currents greater than the discharge rate so they can be treated as a sink for battery energy. Discharging the battery into the system's load may not affect the voltage of the battery or the system load. Further, no additional heat may be generated within the system. Rather, power typically drawn from some other power source coupled with the system is replaced with power drawn from the battery. Since the voltage levels of the system rail and the battery are different, power conversion is needed to allow energy to be put from the battery into the system rail and from the system rail into the battery.

The battery's charge may be applied to the supply rail such that at least a portion of the current pulled from the supply rail is from the rechargeable battery. If the battery and supply rail function at different voltage levels, the voltage level may need to be converted in order for the voltage of the rechargeable battery to be compatible with the voltage level of the supply rail. Similarly, in order to charge the rechargeable battery from the supply rail, the voltage of the supply rail may need to be converted to the voltage level of the battery in order to charge the battery.

If a supply rail operates at a higher voltage level than a battery, to convert the voltage of the supply rail to the voltage level of the battery (such as for charging the battery), a buck regulator controller may be used. In order to convert the voltage of the battery to the voltage level of the supply rail (such as for performing discharge for the purpose of updating a battery “fuel gauge” or supplying backup power), a boost regulator controller may be used. While a switch mode regulator controller may function in either boost or buck mode (also referred to as step-up and step-down mode, respectively), typically a switch mode regulator controller remains in only one of these modes. Therefore, to conduct a voltage conversion from a supply rail operating at a first voltage to a battery operating at a different second voltage, and also from the battery's voltage level to the voltage level of the supply rail would require two regulator controllers, a buck regulator controller and a boost regulator controller (or two switch mode regulator controllers, with one functioning in buck mode and one functioning in boost mode). Such a configuration may require a significant amount of circuit board space and consume a significant amount of power.

Rather, a single switch mode regulator controller may be used. The switch mode regulator controller may be switched from buck mode to boost mode depending on whether the battery is being charged by the supply rail or discharged to the supply rail. Such a configuration may decrease the amount of circuit board space necessary, decrease power consumption and heat dissipation, and/or decrease manufacturing cost (such as through fewer components being required). The switch mode regulator converter may have its mode changed between boost and buck mode by another circuit. A circuit may alter external circuitry coupled with the regulator converter based on whether the regulator is to function in buck or boost mode.

Rather than function only to charge a battery from a supply rail and to discharge the battery to the supply, such a use of switch mode regulator controller may be used in other situations where voltage levels need to be alternatively raised and lowered between voltage levels. As will be evident to those with skill in the art, in the case of a supply rail and a battery, either the battery or the supply rail may have the higher voltage.

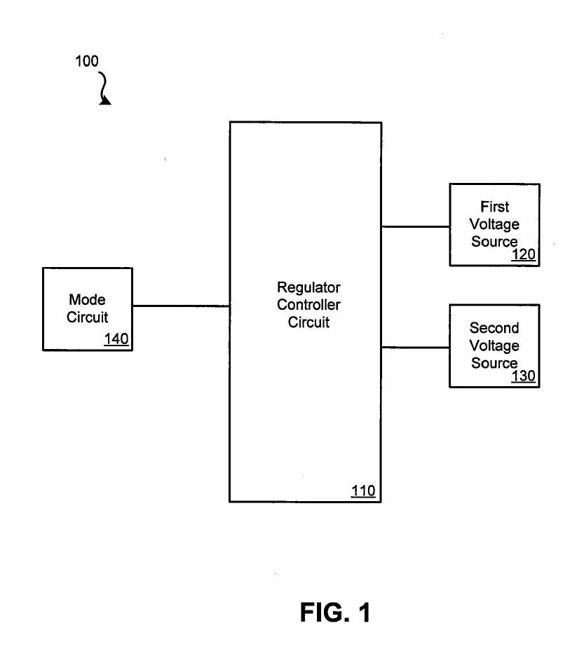

FIG. 1 illustrates a high level block diagram of an embodiment of system 100 having a regulator controller configured for two-way voltage switching. System 100 may include a regulator controller circuit 110, a first voltage source 120, a second voltage source 130, and a mode circuit 140. First voltage source 120 and second voltage source 130 may each function to supply current or sink current. Regulator controller circuit 110 may include a regulator controller, such as a switch mode regulator that is capable of switching between functioning in a buck mode and a boost mode. One possible example of such a switching regulator controller is the LTC3703-5 60V synchronous switching regulator controller manufactured by LINEAR TECHNOLOGY. Other regulator controllers may be possible. Regulator controller circuit 110 may also include various components that function in conjunction with the regulator controller. For example, in order to function properly, the regulator controller may need to be coupled with various MOSFETs, capacitors, resistors and/or diodes. The configuration of such various components may be at least in part determined by the recommended or required circuit layout identified by the manufacturer of the regulator controller.

Regulator controller circuit 110 may be coupled with two voltage sources. First voltage source 120 may represent a supply rail. Typically, such a supply rail may receive power from some form of power supply. Such a power supply may normally be powered by a connection with an electrical outlet, a generator, an engine, or some other system or device capable of creating electrical power. When the power supply of the supply rail is deactivated or no longer available, the supply rail may no longer supply power and voltage to systems, devices and/or circuits. Second voltage source 130 may be a rechargeable battery. This rechargeable battery may serve as a backup power supply for situations such as when the first voltage source or some other voltage source is unavailable. Second voltage source 130 may occasionally need to be recharged and discharged (to test the capacity of the battery). The power to charge second voltage source 130 may be derived from first voltage source 120. The second voltage source 130 may be discharged to first voltage source 130. Besides a supply rail and rechargeable battery, first voltage source 120 and second voltage source 130 may represent other voltage sources.

Mode circuit 140 may set a regulator controller circuit 110 into boost mode or buck mode. In buck mode, a voltage may be converted to a lower voltage. For example, if first voltage source 120 is operating at 15 V and second voltage source 130 is operating at 10 V, regulator controller circuit 110 may be used to convert the 15 V output of first voltage source 120 to recharge second voltage source 130 at 10 V. In boost mode, the voltage of second voltage source 130 may be converted to the higher voltage of first voltage source 120. Returning to the example, the second voltage source 130 operating at 10 V may be converted to the 15 V level of first voltage source 120. This may allow second voltage source to discharge some amount of electrical energy to first voltage source 120.

It may be possible that second voltage source 130, in conjunction with regulator controller circuit 110, may output a voltage to first voltage source 120 while first voltage source 120 is also creating a voltage. For example, if first voltage source 120 is outputting a 15 V supply voltage and regulator controller circuit 110 is functioning in boost mode and outputting 15 V to first voltage source 120, some of the current drawn by circuitry coupled to first voltage source 120 may come from the power supply coupled with first voltage source 120 and some may come from regulator controller circuit 110 boosting second voltage source 130.

For mode circuit 140 to set regulator controller circuit 110 to either boost mode or buck mode, it may be necessary for mode circuit 140 to output a voltage either above or below a threshold voltage level to regulator controller circuit 110. For example, if the voltage level output to regulator controller circuit 110 from mode circuit 140 is greater than 2 V, the regulator controller may function in boost mode. If the voltage level output to regulator controller circuit 110 from mode circuit 140 is less than 1 V, the regulator controller may function in buck mode. Mode circuit 140 may rely on an input, such as an input from some other circuit or user, to determine whether regulator controller circuit 110 should function in buck mode or boost mode.

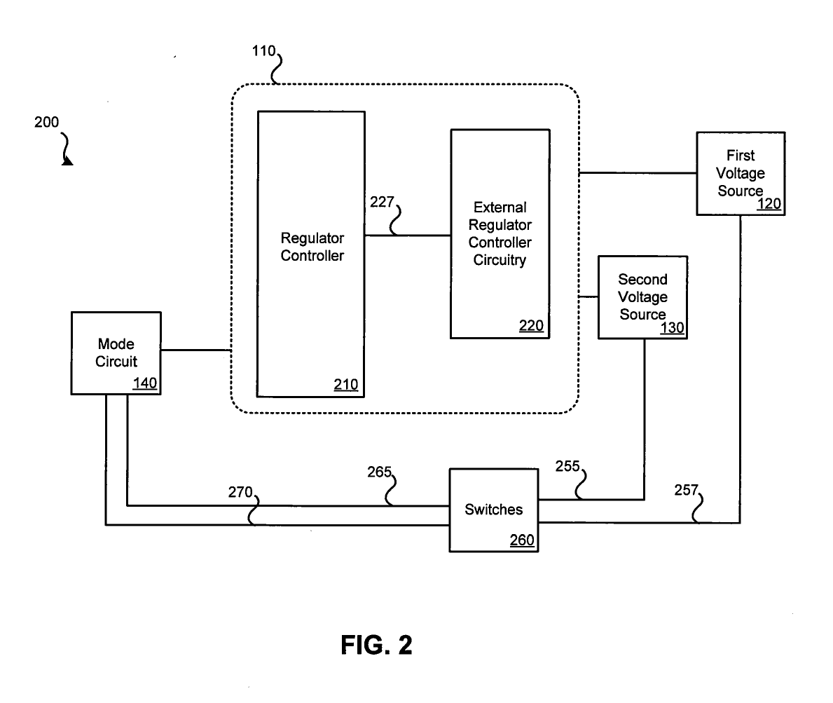

FIG. 2 illustrates another high level block diagram of an embodiment of system 200 that uses a regulator controller configured for two-way voltage switching. System 200 may include: regulator controller 210, external regulator controller circuitry 220, first voltage source 120, second voltage source 130, mode circuit 140, and switches 260.

Regulator controller 210 and external regulator controller circuitry 220 may represent regulator controller circuit 110 of FIG. 1. Regulator controller 210 may represent a switch mode regulator controller, such as a 60 V synchronous switching regulator controller previously described. Such a regulator controller may be in the form of integrated circuit (IC). External regulator controller circuit 220 may include various components, such as capacitors, resistors, MOSFETs, and diodes that are necessary to be coupled with regulator controller 210 in order for regulator controller 210 to function in either buck mode or boost mode. While only one connection 227 is illustrated between regulator controller 210 and external regulator controller circuitry 220, it should be understood that this is for simplicity only: if regulator controller 210 is an IC, multiple pins of the IC may be coupled to various components of external regulator controller circuitry 220.

First voltage source 120 may be coupled with regulator controller circuit 110. First voltage source 120 may also be coupled to external regulator controller circuitry 220. Similarly, second voltage source 130 may be coupled to regulator controller circuit 110 and external regulator controller circuitry 220. First voltage source 120 and second voltage source 130 may be coupled with switches 260. Switches 260 may represent switches; such as analog switches, that are either manually controlled by a user or electrically controlled by the user or by some other circuit. Switches 260 may be used to control whether regulator controller 210 functions in boost mode or buck mode. It should be understood that switch 260 may be used to make a selection of whether to charge or discharge second voltage source 130. If first voltage source 120 is a supply rail and second voltage source 130 is a rechargeable battery, switches 260 may be used to determine whether the battery is discharged to the supply rail or the supply rail is used to charge the battery. First voltage source 120 and second voltage source 130 may represent first voltage source 120 and second voltage source 130 of FIG. 1, respectively, or may represent some other voltage supplies. Further, it should be understood that whether regulator controller 210 is functioning in the boost or buck mode, the power path is not changed. The power path not changing refers to the first voltage source 120 and second voltage source 130 remaining coupled with the same inputs and outputs of regulator controller circuit 110, with the route of current between first voltage source 120 and second voltage source 130 remaining unchanged. To be clear, while the power path may remain unchanged, the direction the current travels along the power path may change.

In order for regulator controller 210 to create a particular voltage level, it may require a feedback loop. Therefore, if first voltage source 120 is being used to apply a voltage to second voltage source 130 (e.g., second voltage source 130 is a rechargeable battery being charged), the connection between regulator controller circuitry 110 and second voltage source 130 may represent the output of regulator controller circuitry 110. As such, this output to second voltage source 130 may be coupled in a feedback loop with regulator controller 210. This may happen via switches 260 and/or mode circuit 140. For example, the output to second voltage source 130 may be routed via connection 255 to switches 260. Switches 260 may enable connection 255 to connection 265. Connection 265 may then be routed to regulator controller 210 either directly or via mode circuit 140. Alternatively, if second voltage source 130 is being used to apply a voltage to first voltage source 120 (e.g., second voltage source 130 is a rechargeable battery being discharged to first voltage source 120), first voltage source 120 may represent the output of regulator controller circuitry 110. As such, this output to first voltage source 120 may be coupled with regulator controller 210. Again, this may happen via switches 260 and/or mode circuit 140. Connection 257 (instead of connection 255) may be coupled to connection 265 by switches 260. Connection 265 may, as previously noted, be routed to regulator controller 210 either directly or via mode circuit 140. While control signals and the feedback applied to regulator controller circuitry 110 may be switched depending on whether the circuit is in boost or buck mode, no power connections need to be switched. As such, the power path remains the same regardless of whether first voltage source 120 is greater than or less than second voltage source 130, and regardless of whether regulator controller 210 is set to a boost mode or a buck mode.

Switches 260 may have one or more additional connections either directly to regulator controller 210 or to mode circuit 140. For example, switches 260 may have a selection input that is coupled to mode circuit 140 via connection 270. Selection input may be used by a user or some other circuit to indicate whether regulator controller 210 should function in buck mode or boost mode. The selection input may result in a voltage level, either above or below some threshold voltage level, being applied to an input of regulator controller 210.

Mode circuit 140 may contain more various components, such as resistors and capacitors, that may be actively coupled with regulator controller 210 only if the regulator is in boost mode or buck mode. For example, regulator controller 210 may require to be coupled with a different configuration of external regulator controller circuitry to function properly in boost mode than in buck mode. However, the different configuration of external regulator controller circuitry may only apply to control signals and where feedback is taken. The power path, that is, the connection of the first voltage source and the second voltage source to the regulator controller may remain the same regardless of whether the regulator controller 210 is in boost mode or buck mode. Based upon the position of switches 260, mode circuit 140 may connect (such that the components are an active part of the circuit) and/or disconnect (such that the components are not an active part of the circuit) various components from regulator controller 210 and/or regulator controller circuitry 110.

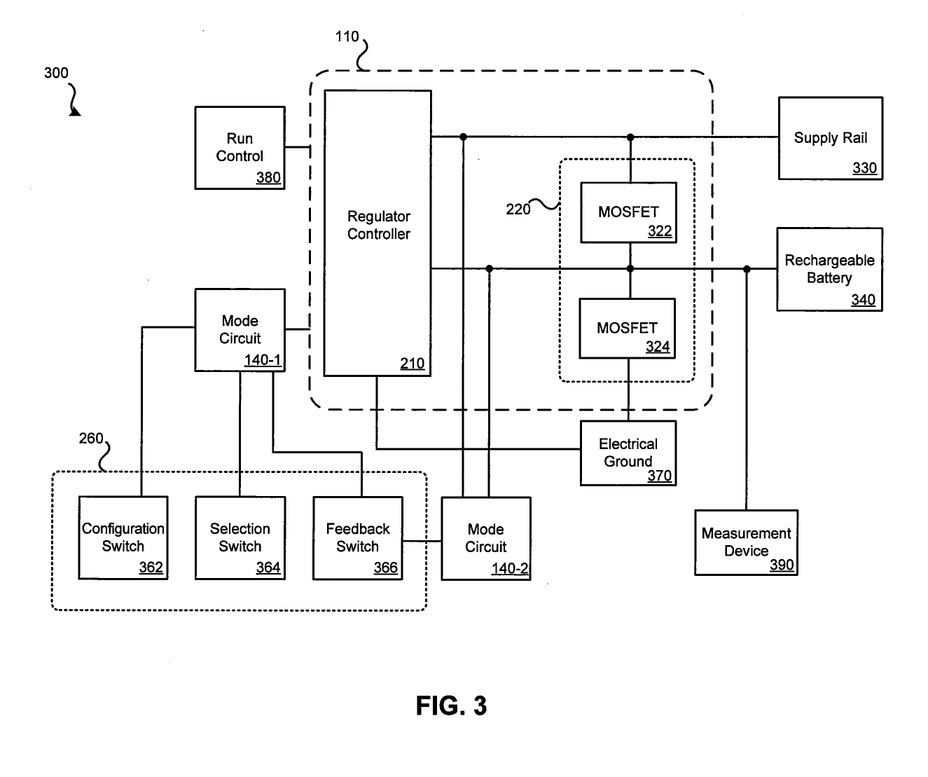

FIG. 3 illustrates a high level block diagram of an embodiment of a system 300 having a regulator controller configured for two-way voltage switching between a rechargeable battery and a supply rail. System 300 may represent system 200 of FIG. 2, system 100 of FIG. 1, or may represent some other system having a regulator controller configured for two-way voltage switching between a rechargeable battery and a supply rail. Supply rail 330 may represent first voltage supply 120 of FIG. 2, and may be coupled with a power supply. Rechargeable battery 340 may represent second voltage supply 130 of FIG. 2. Supply rail 330 may operate at a higher or lower voltage than rechargeable battery 340. Further, as understood by those with skill in the art, voltage sources besides a supply rail coupled with a power supply and a rechargeable battery may be used.

MOSFET 322 and MOSFET 324 may represent a portion of external regulator controller circuitry 220, which may represent external regulator controller circuitry 220 of FIG. 2. MOSFETs 322 and 324 may be coupled with regulator controller 210, supply rail 330, and rechargeable battery 340. These MOSFETs may work in conjunction with regulator controller 210 to convert the voltage level of supply rail 330 to the voltage level of rechargeable battery 340, and the voltage level of rechargeable battery 340 to the voltage level of supply rail 330. Other circuitry, not illustrated, may be part of external regulator controller circuitry 220, such as resistors, capacitors, inductors, and diodes. External regulator controller circuitry 220, regulator controller 210 (which may represent any of the previously described regulator controllers), along with other components of system 300, may be coupled with electrical ground 370.

Switches 260 may represent switches 260 of FIG. 2. Feedback switch 366 may be a manual or electronic switch, such as an electronic analog switch. As those with skill in the art will recognize, other types of switches may be possible. Feedback switch 366 may be used to route the appropriate voltage back to the regulator controller 210 in a feedback loop. When rechargeable battery 340 is being charged, the voltage applied to rechargeable battery 340 may be used as feedback and routed back to regulator controller 210. When rechargeable battery 340 is being discharged to supply rail 330, the voltage applied to the supply rail may be used as feedback and routed back to regulator controller 210. Selection switch 364 may be used to provide an input to regulator controller 210, possibly via mode circuit 140-1, that specifies whether regulator controller 210 should function in boost mode or buck mode. Selection switch 364 may be tied to ground when buck mode is desired and tied to a voltage (such as V_{CC}) above a threshold level, such as 2 V, when boost mode is desired. Configuration switch 362 may enable and/or disable various components of mode circuit 140-1. In some embodiments, switches 260 may be set together. For example, all three switches may be set to a first state for boost mode and a second state for buck mode. Therefore, one signal from another circuit (or physical switch for a user) may be used to control switches 260.

Mode circuit 140, which may include mode circuits 140-1 and 140-2, may connect and disconnect various circuitry from regulator controller circuitry 110 depending on the state of switches 260. For instance, when feedback switch 366 is set to connect the voltage of supply rail 330 to the feedback input of regulator controller circuitry 110, mode circuit 140-2 may actively connect a resistor to the feedback input of regulator controller circuitry 110. Mode circuit 140-1 may actively connect an additional resistor to the feedback input of regulator controller circuitry 110 when rechargeable battery 340 is being discharged to supply rail 330.

Run control 380 may be used to enable and disable regulator controller 210. Run control 380 may also be used for a soft start of regulator controller 210. Further description of run control 380 is provided in the U.S. patent application entitled “Use of a JFET as a Failsafe Shutdown Controller,” identified in the cross-reference section of this document, the entire disclosure of which is incorporated by reference for all purposes.

Measurement device 390 may be a circuit or some other device that is capable of performing measurements that may be used to identify characteristics of rechargeable battery 340, such as its full charge capacity, its remaining capacity, and state of health. Measurements taken by measurement device 390 may be output to some other circuit or device, such as a computer system.

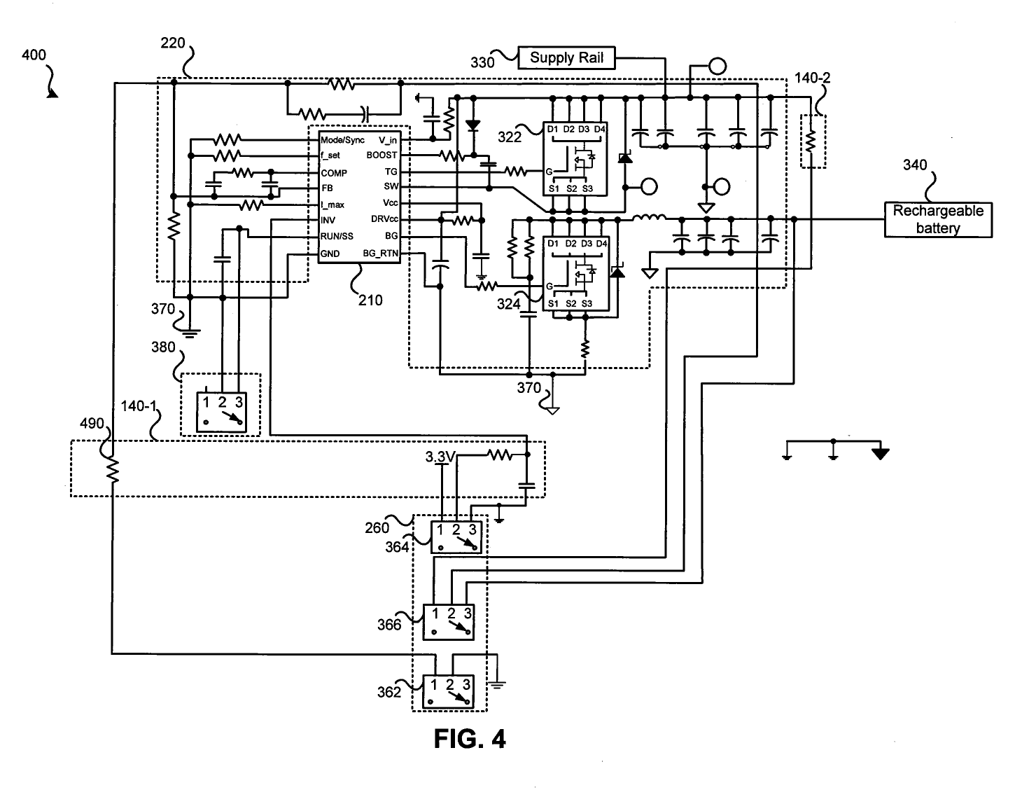

FIG. 4 illustrates a circuit diagram of an embodiment of a system 400 having a regulator controller configured for two-way voltage switching. System 400 may represent a system of FIGS. 1-3, or may represent some other system having a regulator controller configured for two-way voltage switching. Regulator controller 210 may represent regulator controller 210 of FIG. 3 or some other regulator controller. Regulator controller 210 may be the LTC3703-5 60V synchronous switching regulator controller manufactured by LINEAR TECHNOLOGY. Regulator controller 210 may be coupled with external regulator controller circuitry 220, which may include MOSFETs 322 and 324. External regulator controller circuitry 220 may represent external regulator controller circuitry 220 of FIG. 3, or different external regulator controller circuitry. Similarly, MOSFETs 322 and 324 may represent MOSFETs 322 and 324 of FIG. 3.

Run control 380 may represent run control 380 of FIG. 3. Run control 380 may include one or more capacitors and one or more switches to determine when regulator controller 210 is enabled or disabled. Run control 380 may also include a JFET. A voltage source may be coupled to supply rail 330, which may represent supply rail 330 of FIG. 3, first voltage source 120 of FIG. 2, and/or first voltage source 120 of FIG. 1. Similarly, rechargeable battery 340 may represent rechargeable battery 340 of FIG. 3, second voltage source 130 of FIG. 2, and second voltage source 130 of FIG. 1. Electrical ground 370 may represent electrical ground 370 of FIG. 3.

Switches 260 may include three switches: configuration switch 362, selection switch 364, and feedback switch 366. Configuration switch 362 may represent the same switch as configuration switch 362 of FIG. 3. Configuration switch 362 determines whether resistor 490 is actively coupled with external regulator controller circuitry 220. Feedback switch 366 may determine the feedback loop used by regulator controller 210. In system 400, switches 260 may connect poles two to three when regulator controller 210 is to be in the buck mode (e.g., the rechargeable battery is being charged). Switches 260 may connect poles one to two when regulator controller 210 is to be in boost mode (e.g., the rechargeable battery is being discharged to first voltage source 220).

Mode circuit 140-1 may interface switches 260 with regulator controller 210 and/or external regulator controller circuitry 220. Mode circuit 140-1 may represent mode circuit 140-1 of FIG. 3. Mode circuitry 140-1 may include resistor 490. Mode circuit 140-2 may represent mode circuit 140-2 of FIG. 3, and may include a resistor.

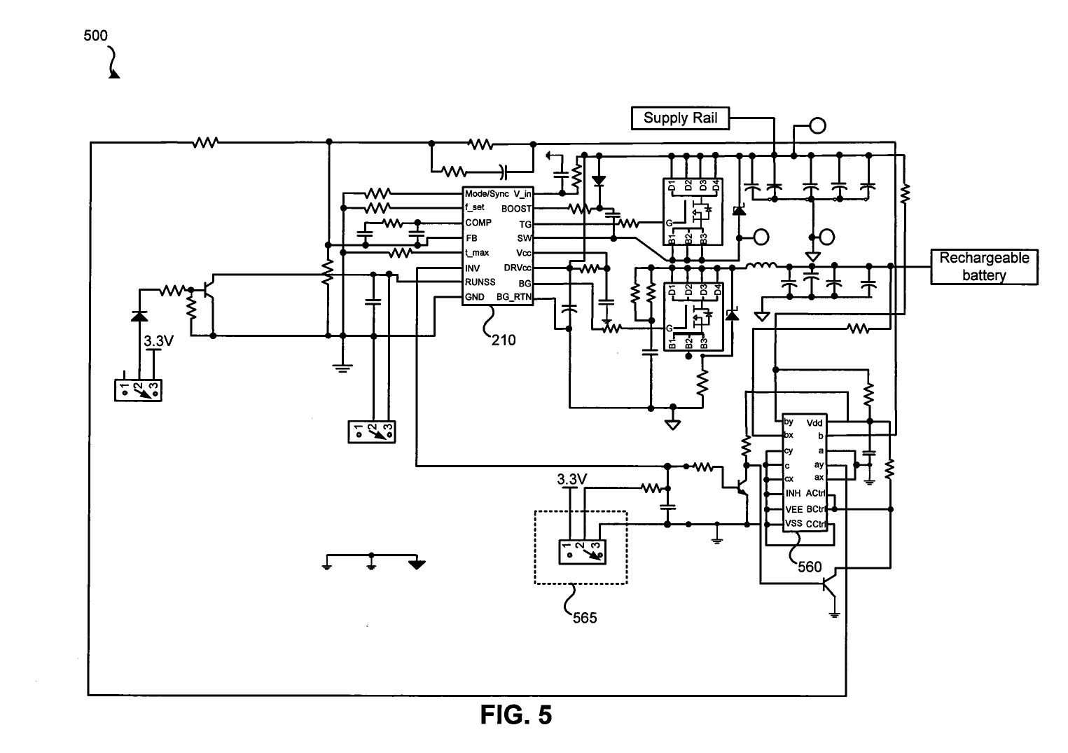

FIG. 5 illustrates another circuit diagram of an embodiment of a system 500 having regulator controller configured for two-way voltage switching. System 500 may use a logic controlled analog switch 560 (which may perform the function of switch 366 of FIG. 4) to also perform the functions of switches 260 of FIG. 4. Logic controlled analog switch 560 may be coupled with one or more other switches. Switch 565 may be used as an input to logic controlled analog switch 560 to determine whether regulator controller 210 is set to boost or buck mode. Logic controlled analog switch 560 may be coupled with various circuitry to allow for proper switching of a feedback loop for regulator controller 210, a signal that selects whether regulator controller 210 is in boost or buck mode, and a configuration signal that alters what components are actively coupled with regulator controller 210 and external regulator controller circuitry. As will be understood by those of skill in the art, other forms of switches besides logic controlled analog switch 560 are possible.

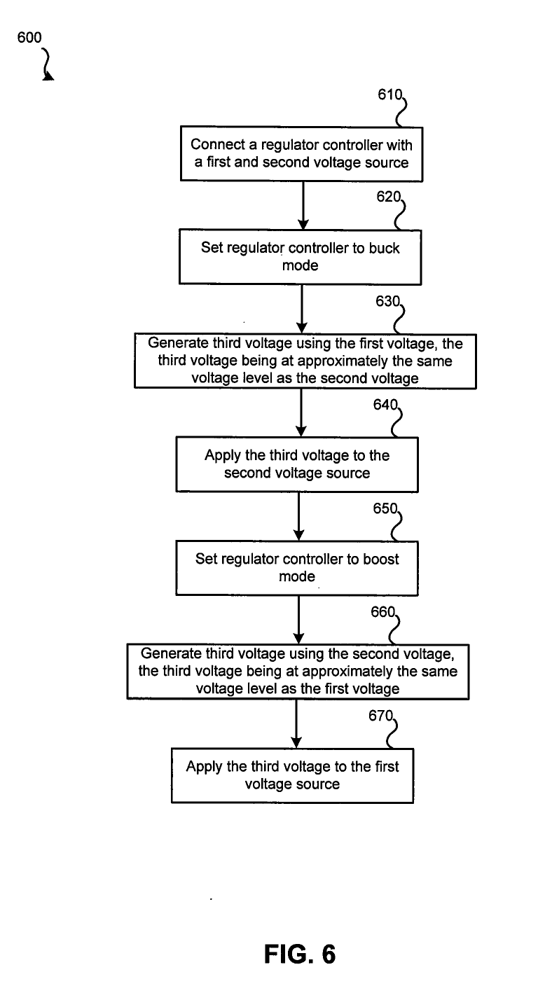

The systems described in FIGS. 1-5 may be used to perform various methods of converting a first voltage to a second voltage, and converting the second voltage to the first voltage using a single regulator controller. In method 600, the first voltage is greater in magnitude than the second voltage. The first voltage may be created by a voltage supply connected with a supply rail, and the second voltage may be created by a rechargeable battery. Alternatively, first voltage may be created by a rechargeable battery, and the second voltage may be created by a voltage supply connected with a supply rail. FIG. 6 illustrates an embodiment of a method 600 for two-way voltage switching. It should be understood that a system could call for either a charge or discharge first, and that a period of time when the system is in a charge or discharge mode is not necessarily followed by the other mode.

At block 610, a regulator controller, such as a synchronous switching regulator controller, may be coupled with first and second voltage sources. These voltage sources may operate at different voltage levels.

At block 620, the regulator may be set to buck mode. Setting the regulator to buck mode may involve actively connecting and/or disconnecting components, such as resistors and/or capacitors, using switches or other switching devices that are used for controlling feedback and control signals to the regulator controller. The power path of the first voltage source and the second voltage source with the regulator controller remains unchanged. As those with skill in the art will recognize, while method 600 describes the regulator controller being set to buck mode first, it may also be possible to initially set the regulator controller to boost mode.

At block 630, energy is drawn from the first voltage source to create the third voltage and apply it to the second voltage source using the regulator. This third voltage may be the same voltage level, slightly greater in magnitude, or approximately the same voltage level, as the second voltage of the second voltage source.

At block 640, the third voltage may be applied to the second voltage source. If the second voltage source is a rechargeable battery, applying the third voltage (which is slightly greater than, at, or approximately at the same voltage level as the rechargeable battery) may charge the rechargeable battery. During normal operation, the regulator controller may remain in buck mode, thereby charging the rechargeable battery for lengthy periods of time (e.g., continuously unless the power supply coupled with the first voltage source is absent and/or the rechargeable battery is being discharged). Power may only be drawn from the rechargeable battery if the power supplied by the first voltage source is lost or the capacity of the battery is being tested.

At block 650, the regulator controller may be set to boost mode. The regulator controller may be triggered to enter boost mode by an input to the regulator controller being switched to high or low by some other circuit, device, or possibly by a user. Whether the regulator is in boost or buck mode, the power path from the first voltage source to the second voltage source remains unchanged. Rather, only control signals and feedback signals are adjusted when switching between modes.

At block 660, the boost mode of the regulator allows for generation of a third voltage using energy from the second voltage source. The third voltage may be the same voltage level, slightly greater than, or approximately the same voltage level, as the first voltage level of the first voltage source.

At block 670, the third voltage may be applied to the first voltage source. If the first voltage source is a supply rail coupled to a power supply, applying the third voltage may either replace the power supply (which may be disabled, such as due to a power outage or other power interruption) or may supplement the power supply. For example if the load on the supply rail typically draws 10 A, the power supply may supply 8 A, while the third voltage generated from the second voltage supply may supply the remaining 2 A. The third voltage may be generated from the second voltage to discharge part or all of the electrical energy stored in the second voltage supply. Such a discharge may be used to determine the capacity of a rechargeable battery that is the second voltage supply.

As those with skill in the art will recognize, the second voltage source may have a higher voltage level than the first voltage source. In such a situation, the regulator controller may be set to boost mode to generate the third voltage using the first voltage, such as at block 630. Similarly, the regulator controller may be set to buck mode to generate the third voltage using the second voltage, such as at block 660. Further, while method 600 shows the regulator controller being set to buck mode once and boost mode once, it should be understood that the regulator controller may switch between these modes many times.

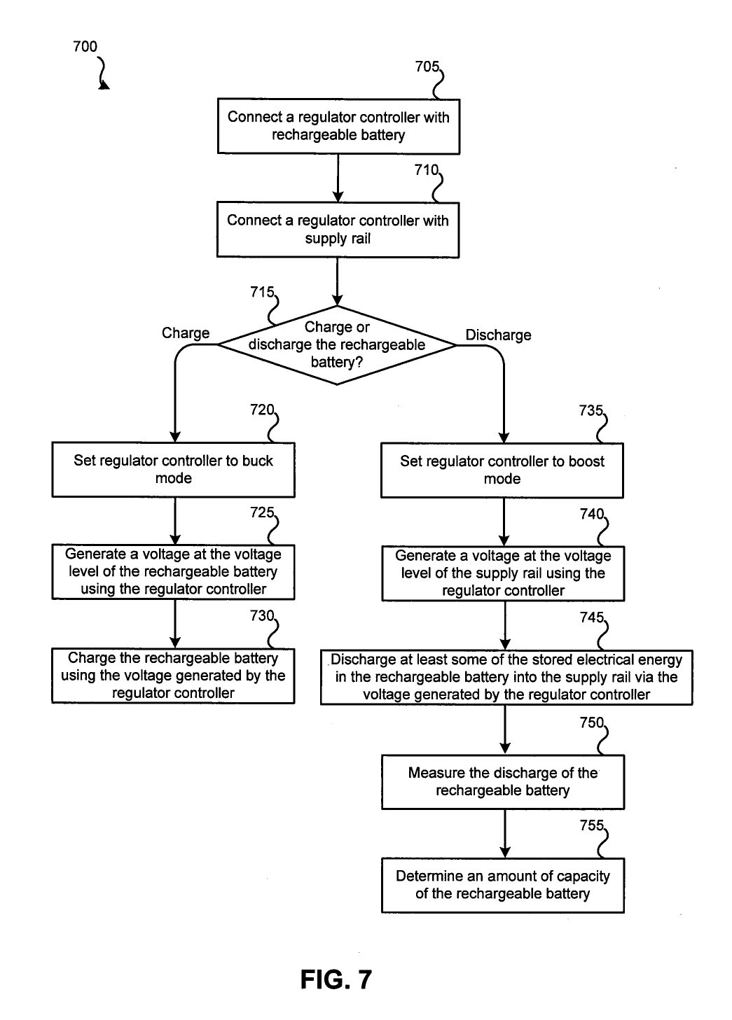

FIG. 7 illustrates an embodiment of a method 700 for two-way voltage switching between a rechargeable battery and a supply rail coupled with a power supply. While method 700 focuses on a rechargeable battery and a supply rail coupled with a power supply, it should be understood that other voltage sources may also be used. In method 700 the voltage level of battery is less than the voltage level of supply rail. Method 700 may represent method 600 of FIG. 6, or may represent a different method. Method 700 may be performed using the systems presented in FIGS. 1-5. It may be possible to perform method 700 using other systems.

At block 705, a regulator controller may be coupled with a rechargeable battery. This rechargeable battery may function at a particular voltage level. For example, the rechargeable battery may have a voltage level of 10.5 V. The rechargeable battery may be connected as the second voltage source. At block 710, the regulator controller may be coupled with a supply rail (that is coupled to a power supply). The power supply and supply rail may also function at a particular voltage level, for example the supply rail may function at a voltage level of 12 V. The supply rail may be connected as the first voltage supply.

At block 715, depending on whether the rechargeable battery is to be charged or discharged, method 700 may vary. If the rechargeable battery is to be charged, method 700 may proceed to block 720. At block 720, the regulator controller may be set to buck mode. The regulator controller may be set to buck mode by one or more control signals being applied to the regulator controller. For instance, a signal received from a switch, such as a selection switch, may be used to determine whether the regulator controller is in buck or boost mode.

At block 725, the regulator controller may generate (possibly using external regulator controller circuitry) a voltage at, slightly above, or approximately the voltage level of the rechargeable battery using the voltage from the supply rail. Therefore, if the supply rail is functioning at 12 V and the rechargeable battery is functioning at 10.5 V, the regulator controller may use the 12 V level of the supply rail to generate the 10.5 V level of the rechargeable battery. The generation of the voltage by the regulator controller may be referred to as the generation of a third voltage (with the first and second voltages referring to 12 V and 10.5 V). It should be understood that while the third voltage, at block 725, is intended to be 10.5 V, this voltage generated by the regulator controller be approximate, slight variation may exist.

At block 730, the rechargeable battery may be charged using the third voltage, which is about 10.5 V, generated by the regulator controller using the 12 V supply rail. Therefore, energy is being transferred from the supply rail to the rechargeable battery.

Returning to block 715, if, instead of charging the rechargeable battery, the rechargeable battery is to be discharged, method 700 may proceed to block 735. The rechargeable battery may be discharged in order to determine the capacity of the rechargeable battery. Other characteristics of the rechargeable battery may also be measured by discharging at least a portion of the rechargeable battery's charge. At block 735, the regulator controller may be set to boost mode. The regulator controller may be set to boost mode by one or more control signals being applied to the regulator controller. For instance, a signal received from a switch, such as the switch referred to at block 720, may be used to determine whether the regulator controller is in buck or boost mode.

At block 740, the regulator controller may generate (possibly using external regulator controller circuitry) a voltage at, slightly above, or near the voltage level of the supply rail using the voltage from the rechargeable battery. Therefore, if the supply rail is functioning at 12 V and the rechargeable battery is functioning at 10.5 V, the regulator controller may use the 10.5 V level of the rechargeable battery to generate the 12 V level of the supply rail. As detailed in regard to block 725, the generation of the voltage by the regulator controller may be referred to as the generation of a third voltage. It should be understood that while the third voltage, at block 740, is intended to be 12 V, this voltage generated by the regulator controller may only be approximate; slight variations may exist. The power path of the generation of the voltage at block 740 may remain substantially unchanged from the power path used to generate the voltage at block 725.

At block 745, at least some of the stored electrical energy in the rechargeable battery may be discharged to the supply via the voltage generated by the regulator controller. If the rechargeable battery is being used to power one or more circuits, systems, and/or devices typically powered by the supply rail, the rechargeable battery may be operated until the rechargeable battery is depleted, or nearly depleted, of electrical energy (or the power from the power source coupled to the supply rail is restored). If the rechargeable battery is being discharged to measure one or more characteristics of the rechargeable battery, only a portion, possibly a set portion, of the electrical energy stored in the rechargeable battery may be discharged.

At block 750, during, or following, the discharge of block 745, measurements of the discharge of the rechargeable battery may be taken. At block 755, these measurements may be used to determine an amount of capacity at the rechargeable battery. Also, other characteristics of the rechargeable battery may also be determined based on the measurements at block 750.

In method 700, the rechargeable battery has a lower voltage than the supply rail. However, in some embodiments, the rechargeable battery has a greater voltage than the supply rail and the rechargeable battery is connected as the second voltage source. At block 720, the boost mode would be used instead of the buck mode to charge the battery using energy supplied by the supply rail. At block 735, the buck mode would be used in place of the boost mode to discharge energy from the rechargeable battery to the supply rail.

In some embodiments, the rechargeable battery is connected as the first voltage supply and the supply rail may be connected as the second voltage supply. If the rechargeable battery voltage is less than the voltage of the supply rail, the buck mode may be used at block 720 to charge the rechargeable battery. At block 735, the boost mode may be used to discharge the battery to the supply rail.

Further, in some embodiments, the rechargeable battery is connected as the first voltage supply and has a greater voltage than the supply rail. In such embodiments, at block 720 the boost mode of the regulator would be used to charge the battery from the supply rail; and, at block 735, the buck mode would be used to discharge the battery to the supply rail.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A method may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for performing two-way voltage switching using a regulator, the system comprising:
a first voltage supply circuit, wherein the first voltage supply circuit at least occasionally supplies at least one other circuit with a first voltage;
a second voltage supply circuit, wherein:
the second voltage supply circuit at least occasionally supplies at least one other circuit with a second voltage; and
the second voltage is lower in magnitude than the first voltage;
the regulator, wherein:
the regulator has a buck mode and a boost mode;
the regulator switches between the buck mode and the boost mode based on a mode input; and
the regulator is coupled with the first voltage supply circuit and the second voltage supply circuit; and
a mode module, comprising a selection input, a boost configuration circuit and a buck configuration circuit, wherein:
the mode module is coupled with the first voltage supply circuit and the second voltage supply circuit;
the mode module, based on the selection input, functions in a boost configuration or a buck configuration;
the boost configuration provides the mode input to set the regulator to boost mode;
the buck configuration provides the mode input to set the regulator to buck mode; and
the selection input activates the boost configuration or the buck configuration of the mode module.

2. The system of claim 1, wherein:
when the mode module is in the boost configuration, the regulator causes the generation of a third voltage, using the second voltage, that is applied to the first voltage supply circuit; and
the third voltage is approximately equal to the first voltage.

3. The system of claim 1, wherein:
when the mode module is in the buck configuration, the regulator causes the generation of a third voltage, using the first voltage, that is applied to the second voltage supply circuit; and
the third voltage is approximately equal to the second voltage.

4. The system of claim 1 wherein the first voltage supply circuit is a rechargeable battery.

5. The system of claim 1 wherein the second voltage supply circuit is a rechargeable battery.

6. The system of claim 5, wherein, when the mode module is in the boost configuration, an amount of electrical energy stored in the rechargeable battery is converted from the second voltage level to the first voltage level and discharged into the first voltage supply circuit.

7. The system of claim 5, wherein, when the mode module is in the buck configuration, the first voltage of the first voltage supply circuit is converted to charge the rechargeable battery at the second voltage.

8. The system of claim 1, further comprising at least one switch, wherein the at least one switch outputs the selection input to the mode module.

9. The system of claim 8, wherein the at least one switch is a logic controlled analog switch.

10. The system of claim 8, wherein the regulator is a synchronous switching regulator controller.

11. A method for creating a first voltage using a second voltage, and the second voltage using the first voltage, the method comprising:
transitioning a regulator to a buck mode, wherein the regulator has a boost mode and the buck mode;
generating the second voltage using the regulator while the regulator is in the buck mode, wherein the first voltage is used to create the second voltage;
applying the second voltage generated using the regulator and the first voltage to a second voltage source;
transitioning the regulator to the boost mode;
generating the first voltage using the regulator while the regulator is in the boost mode, wherein the second voltage is used to create the first voltage; and
applying the first voltage generated using the regulator to a first voltage source.

12. The method of claim 11, wherein the second voltage source is a rechargeable battery, and applying the second voltage generated using the regulator and the first voltage to the rechargeable battery comprises recharging the rechargeable battery.

13. The method of claim 12, wherein applying the first voltage generated using the regulator and the second voltage comprises discharging the rechargeable battery.

14. The method of claim 13, further comprising:
measuring the discharge of the rechargeable battery; and
determining an amount of capacity of the rechargeable battery at least partially based on measuring the discharge of the rechargeable battery.

15. The method of claim 11, wherein the regulator is a synchronous switching regulator controller.

16. A system for performing two-way voltage switching, the system comprising:
a first means for regulating a voltage, wherein the first means functions in a boost mode and a buck mode based on a mode input;
a second means, wherein:
the second means creates a first voltage; and
the second means is coupled with the first means;
a third means, wherein:
the third means creates a second voltage;
the third means is coupled with the first means; and
the second voltage is lower than the first voltage; and
a fourth means, wherein:
the fourth means is coupled with the first means;
the fourth means enables either the boost mode or the buck mode using the mode input;
when the first means is in the boost mode, the second voltage is used to generate a third voltage that is supplied to the second means, wherein the first voltage and the third voltage are approximately equal; and
when the first means is in the buck mode, the first voltage is used to generate the third voltage that is supplied to the third means, wherein the second voltage and the third voltage are approximately equal.

17. The system of claim 16, wherein the first means comprises a synchronous switching regulator controller.

18. The system of claim 16, wherein the second means is a rechargeable battery.

19. The system of claim 16, wherein the third means is a rechargeable battery.

20. The system of claim 16, further comprising:
a fifth means for measuring the discharge of the third means; and
a sixth means for determining an amount of capacity of the third means at least partially based on measuring the discharge of the discharge of the third means.

21. The method of claim 19, wherein when the first means is in the buck mode, the rechargeable battery is being charged.
